(19) United States
(12) Patent Application Publication
(10) Pub. No.: US 2015/0287222 A1
(43) Pub. Date: Oct. 8, 2015

(54) SYSTEMS AND METHODS FOR ACCELERATED PARAMETER MAPPING

(71) Applicant: University of Virginia Patent Foundation, Charlottesville, VA (US)

(72) Inventors: Li Zhao, Charlottesville, VA (US); Craig H. Meyer, Charlottesville, VA (US)

(21) Appl. No.: 14/677,866

(22) Filed: Apr. 2, 2015

Related U.S. Application Data
(60) Provisional application No. 61/974,237, filed on Apr. 2, 2014.

(51) Int. Cl. G06T 11/00

(52) U.S. Cl. CPC G06T 11/005; G06T 2207/10004; G06T 2207/10096; G06T 2207/30004

(57) ABSTRACT

Some aspects of the present disclosure relate to tissue parameter mapping. In one embodiment of the present disclosure, a method includes receiving undersampled k-space data corresponding to a dynamic physiological process in an area of interest of a subject. The method also includes estimating, from the undersampled k-space data, one or more respective tissue parameter values representing a respective state of the dynamic process at each point in time of a predetermined plurality of points in time during the acquisition. The estimation includes unscented Kalman filtering. The method also includes generating one or more tissue parameter maps using the respective plurality of estimated tissue parameter values.

### CROSS-REFERENCE TO RELATED APPLICATION

This application claims priority to and benefit under 35 U.S.C §119(e) of U.S. Provisional Patent Application Ser. No. 61/974,237, entitled “Direct & Accelerated Parameter Mapping using the Unscented Kalman Filter,” filed Apr. 2, 2014, which is hereby incorporated by reference in its entirety as if fully set forth below.

### STATEMENT OF RIGHTS UNDER FEDERALLY-SPONSORED RESEARCH

The invention was made in part with U.S. Government support under Grant R01 HL079110 awarded by the National Institutes of Health. The U.S. Government has certain rights in the invention.

Some references, which may include patents, patent applications, and various publications, are cited in a reference list and discussed in the disclosure provided herein. The citation and/or discussion of such references is provided merely to clarify the description of the present disclosure and is not an admission that any such reference is “prior art” to any aspects of the present disclosure described herein. All references cited and discussed in this specification are incorporated herein by reference in their entireties and to the same extent as if each reference was individually incorporated by reference. In terms of notation, hereinafter, “(n)” may represent the n^{th} reference cited in the reference list. For example, “(5)” represents the 5^{th} reference cited in the reference list, namely, Baudrexel et al. Quantitative Mapping of T1 and T2* Discloses Nigral and Brainstem Pathology in Early Parkinson's Disease. Neuroimage 2010; 51:512-520.

### BACKGROUND

Magnetic resonance imaging (“MRI”) often relies on image contrast to reveal pathology, and it has proven to be a highly effective diagnostic technique even without quantitative measures of the underlying parameters producing the image contrast. Even so, quantitative tissue parameter mapping shows substantial promise for improving the characterization of pathologies such as tumor (1, 2), stroke (3), cardiac edema (4) and Parkinson's disease (5). In comparison to a conventional relaxation-weighted image such as a T2-weighted image, a quantitative parameter map can help to minimize user dependence, detect subtle differences between tissues, improve specificity, and aid diagnosis when the pathology is uniformly distributed across the region of interest. The accuracy of basic parameter maps also limits the quantification of other MRI parameters. For example, an accurate T1 map improves the quantification of cerebral blow flow in arterial spin labeling (6).

To achieve accurate parameter estimation (7), several measurements are usually required along the parameter encoding direction (p-space) (8). For example, T2 mapping requires measurements at multiple echo times, and the resulting long acquisition times have slowed its adoption. Thus, an accelerated parameter mapping method is desirable.

Moderate acceleration factors of 2-4 can be achieved using conventional parallel imaging methods (9, 10), but the intrinsic signal-to-noise ratio (“SNR”) penalty limits higher acceleration factors. Higher acceleration factors have been reported using compressed sensing methods (11) that enforce sparsity in k-space and p-space (12, 13). One of the successful constraints for compressed sensing acceleration is model-based sparsity. This assumes that the image structures are similar for each measurement and signals from different pixels follow a similar evolution pattern in p-space. By enforcing sparsity in the domain of a T2 decay model, compressed sensing methods are used to recover images and improve T2 estimation. One approach recovers T2 weighted images by linearizing the T2 decay model. A dictionary is trained to represent T2 decay signals sparsely by a linear combination of only a few elements. This can be an orthogonal dictionary from principal component analysis (14) or an over-complete dictionary obtained using the K-SVD technique (8). Most of these methods estimate the T2 map in two steps: reconstruction of T2 weighted images from k-space data, followed by regression of the T2 map pixel by pixel in image space.

High acceleration factors can also be achieved by nonlinear inversion of the measurement function (15, 16). These studies employed the conjugate gradient method to pursue the parameter map, where a nonlinear T2 decay model was solved as data fidelity term. While helpful in achieving high acceleration factors, this approach may be limited. For instance, the nonlinear inversion is computationally complex when using multiple echo time (“TE”) measurements. Further, it requires regularization constraints to avoid noise amplification during iteration, which would otherwise limit accuracy.

In MRI, measurement is not made of the T2 map directly, but rather Fourier-encoded images that are nonlinear functions of local T2. Each acquired signal corresponds to samples of the T2 map in combined k-p-space. When multiple TEs are used to sample the signal decay curve, one can observe T2 in k-p-space at multiple encoding states. This is similar to the process of tracking the location of a moving object by multiple detectors. This viewpoint suggests that it should be possible to track the parameter of interest, T2, by considering it as the state of a dynamic process, while modeling k-p-space sampling using a measurement function related to this dynamic process.

The Kalman filter has been widely used in state tracking and parameter estimation. It is an efficient optimal estimator that uses the previous measurements to estimate the current state recursively. Recently, Sümbül et al. (17) and Feng et al. (18) successfully adapted it to dynamic MRI by exploiting spatial and temporal redundancy. As research has shown (19), in parameter mapping, it is possible to treat the parameter map as the state of a dynamic system, model the parameter encoding and Fourier encoding steps in one measurement function, and use the Kalman filter to improve T2 estimates as more measurements are introduced. While helpful for improving T2 estimates, the classic Kalman filter is linear and thus, may not be configured to accurately address a nonlinear problem such as this.

It is with respect to these and other considerations that the various embodiments described below are presented.

### SUMMARY

The present disclosure relates generally to MRI, and more particularly to systems and methods for tissue parameter (e.g., T1, T2, T2*, perfusion parameters, diffusion parameters) mapping using an unscented Kalman filter (“UKF”) (20). Through the UKF, the disclosed systems and methods may utilize a paradigm that combines image reconstruction and model regression as a parameter state-tracking problem to accelerate parameter mapping.

In one aspect, a method for T2 mapping is disclosed. In one exemplary embodiment, the method also includes acquiring, by a magnetic resonance imaging (MRI) system, undersampled k-space data corresponding to a dynamic physiological process in an area of interest of a subject. The method also includes estimating, from the undersampled k-space data, one or more respective T2 values representing a respective state of the dynamic process at each point in time of a predetermined plurality of points in time during the acquisition. The estimation includes unscented Kalman filtering. The method also includes generating one or more T2 maps using the respective plurality of estimated T2 values.

In another aspect, a system for tissue parameter mapping is disclosed. In one exemplary embodiment, the system includes a data collection device configured to collect undersampled k-space data corresponding to a dynamic physiological process in an area of interest of a subject. The system also includes an image processing device coupled to the image data acquisition device. The image processing device includes an estimating module configured to estimate, from the undersampled k-space data, one or more tissue parameter values associated with a state of the dynamic process at each of a predetermined plurality of points in time during the acquisition. The image processing device also includes include a generating module configured to generate one or more tissue parameter maps using the respective plurality of estimated tissue parameter values.

In another aspect, a method for tissue parameter mapping is disclosed. In one exemplary embodiment, the method includes receiving undersampled k-space data corresponding to a dynamic physiological process in an area of interest of a subject. The method also includes estimating, from the undersampled k-space data, one or more respective tissue parameter values representing a respective state of the dynamic process at each point in time of a predetermined plurality of points in time during the acquisition. The estimation includes unscented Kalman filtering. The method further includes generating one or more tissue parameter maps using the respective plurality of estimated tissue parameter values.

In another aspect, a non-transitory computer-readable medium is disclosed. In one exemplary embodiment, the non-transitory computer-readable medium has stored computer-executable instructions that, when executed by one or more processors, cause a computer to perform functions that include receiving undersampled k-space data corresponding to a dynamic physiological process in an area of interest of a subject. The functions performed also include estimating, from the undersampled k-space data, one or more respective tissue parameter values representing a respective state of the dynamic process at each point in time of a predetermined plurality of points in time during the acquisition. The estimation may include unscented Kalman filtering. Further, the functions performed also include generating one or more tissue parameter maps using the respective plurality of estimated tissue parameter values.

Other aspects and features according to the present disclosure will become apparent to those of ordinary skill in the art, upon reviewing the following detailed description in conjunction with the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a system diagram illustrating an imaging system capable of implementing aspects of the present disclosure in accordance with one or more exemplary embodiments.

FIG. 2 is a computer architecture diagram showing a general computing system capable of implementing aspects of the present disclosure in accordance with one or more exemplary embodiments.

FIG. 3 is a flow chart illustrating a method for T2 mapping in accordance with one or more exemplary embodiments.

FIG. 4 is a flow chart illustrating an unscented Kalman filtering method in accordance with one or more exemplary embodiments.

FIG. 5 is a flow chart illustrating a method for tissue parameter mapping in accordance with one or more exemplary embodiments.

FIG. 6A is a flow chart illustrating a conventional T2 mapping process for reconstructing T2-weighted images from k-space data.

FIG. 6B is a flow chart illustrating an exemplary T2 mapping process that tracks the T2 value in parameter-space using a UKF to produce a T2 map directly from the k-space, in accordance with one or more exemplary embodiments.

FIG. 7A is a three-dimensional graph showing an exemplary fully sampled T2 data sampling pattern in k-p-space, in accordance with one or more exemplary embodiments.

FIG. 7B is a two-dimensional graph illustrating an exemplary fully sampled T2 data sampling pattern in k-p-space, in accordance with one or more exemplary embodiments.

FIG. 7C is a two-dimensional graph showing an exemplary undersampling T2 data sampling pattern for a UKF with an acceleration rate of 4, in accordance with one or more exemplary embodiments.

FIG. 8A is a two-dimensional graph illustrating performance of an exemplary embodiment of a disclosed method for tissue parameter mapping using a UKF as a function of SNR.

FIG. 8B is a two-dimensional graph illustrating performance of an exemplary embodiment of a disclosed method for tissue parameter mapping using a UKF as a function of the number of echoes.

FIG. 8C is a two-dimensional graph showing performance of an exemplary embodiment of a disclosed method for tissue parameter mapping using a UKF as a function of the echo spacing in milliseconds.

FIG. 9 is a matrix chart showing an exemplary T2 estimation in Monte Carlo simulations with a nonlinear inversion method and an exemplary embodiment of a disclosed method for T2 mapping using a UKF.

FIG. 10A is a two-dimensional graph illustrating an exemplary quantification of the error at various undersampling ratios in the estimated T2 maps in simulation with a nonlinear inversion method and an exemplary embodiment of a disclosed method for T2 mapping using a UKF.

FIG. 10B is a two-dimensional graph illustrating an exemplary structural similarity index at various undersampling ratios in the estimated T2 maps in simulation with a nonlinear inversion method and an exemplary embodiment of a disclosed method for T2 mapping using a UKF.

FIG. 11 is a matrix chart showing exemplary T2 maps for simulations with a nonlinear inversion method and an exemplary embodiment of a disclosed method for two-parameter mapping using a UKF.

FIG. 12A is a two-dimensional graph illustrating an exemplary quantification of the error for parameter mapping undersampled volunteer data at various undersampling ratios with a nonlinear inversion method and an exemplary embodiment of a disclosed method for T2 mapping using a UKF.

FIG. 12B is a two-dimensional graph illustrating an exemplary structural similarity index for parameter mapping undersampled volunteer data at various undersampling ratios with a nonlinear inversion method and an exemplary embodiment of a disclosed method for T2 mapping using a UKF.

FIG. 13 is a matrix chart showing exemplary T2 maps for accelerated acquisition simulations with a nonlinear inversion method and an exemplary embodiment of a disclosed method for two-parameter mapping using a UKF.

### DETAILED DESCRIPTION

Aspects of the present disclosure relate to magnetic resonance imaging (“MRI”), specifically systems and methods for tissue parameter mapping using an unscented Kalman filter (“UKF”). Among other benefits and advantages, practicing aspects of the present disclosure in accordance with one or more example embodiments described herein provides for accurate tissue parameter mapping at various undersampling ratios.

Although example embodiments of the present disclosure are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise.

Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose.

It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” or “patient” may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to a human (e.g. rat, dog, pig, monkey), etc. It should be appreciated that the subject may be any applicable human patient, for example.

In one aspect, a method for T2 mapping is disclosed. In some exemplary embodiments, the method may include acquiring, by a magnetic resonance imaging (MRI) system, undersampled k-space data corresponding to a dynamic physiological process in an area of interest of a subject. The method may also include estimating, from the undersampled k-space data, one or more respective T2 values representing a respective state of the dynamic process at each point in time of a predetermined plurality of points in time during the acquisition. The estimation may include unscented Kalman filtering. The method may further include generating one or more T2 maps using the respective plurality of estimated T2 values.

In some embodiments, the unscented Kalman filtering may include performing a state transition function associated with one or more transitions between the states of the dynamic process. Further, the unscented Kalman filtering may include performing a measurement function associated with a relationship between the one or more estimated T2 values and an acquired signal corresponding to the undersampled k-space data. In one embodiment, the measurement function may single-handedly model T2 encoding and Fourier encoding steps. In another embodiment, the state transition function may include combining the one or more respective T2 values associated with the respective state of the dynamic process with a noise value associated with the respective state. In yet another embodiment, the measurement function may include combining a noise value associated with the MRI system with a product of an undersampling pattern at a particular state of the states of the dynamic process, a Fourier transform operator, a coil sensitivity map associated with the MRI system, and a T2-weighted image at the particular state.

In other embodiments, acquiring the undersampled k-space data may include using a multiple contrast spin echo sequence, each echo being configured to acquire a phase encoding value selected according to a predetermined undersampling pattern. In further embodiments, the predetermined undersampling pattern may include a plurality of phase-encoding lines and a plurality of outer k-space lines at each echo, the plurality of phase-encoding lines having the same quantity of phase-encoding lines at each echo.

In some embodiments, the acquisition may include using a repetition time of about 2 seconds. In other embodiments, the acquisition may include using an echo spacing of about 5.5 milliseconds. In some embodiments, the undersampled k-space data may have an undersampling factor of at least 4. In other embodiments, the undersampled k-space data may have an undersampling factor of at least 8.

In other embodiments, the method may also include estimating, from the undersampled k-space data, one or more of a respective T1, T2*, perfusion parameter (e.g., cerebral blood flow, mean transit time, arterial transit time, myocardial blood flow), or diffusion parameter (e.g., apparent diffusion coefficient) value representing a respective state of the dynamic process at each point in time of a predetermined plurality of points in time during the acquisition. The T1, T2*, perfusion parameter, or diffusion parameter estimation may include unscented Kalman filtering. The method may further include generating one or more of a T1, T2*, perfusion parameter, or diffusion parameter map using the respective plurality of estimated T1, T2*, perfusion parameter, or diffusion parameter values.

In some embodiments, generating the one or more T2 maps may include generating the one or more T2 maps directly from the undersampled k-space data. In other embodiments, the method may further include generating one or more T2-weighted images based on the one or more T2 maps.

In some embodiments, estimating the one or more respective T2 values may further include estimating, from the undersampled k-space data, one or more respective proton density values representing the respective states of the dynamic process at each point in time of the predetermined plurality of points in time during the acquisition. Further, generating the one or more T2 maps further may include generating the one or more T2 maps using the respective plurality of estimated T2 values and the respective plurality of estimated proton density values.

In another aspect, a system for tissue parameter mapping is disclosed. In some exemplary embodiments, the system may include a data collection device configured to collect undersampled k-space data corresponding to a dynamic physiological process in an area of interest of a subject. The system may also include an image processing device coupled to the image data acquisition device. The image processing device may include an estimating module configured to estimate, from the undersampled k-space data, one or more tissue parameter values associated with a state of the dynamic process at each of a predetermined plurality of points in time during the acquisition. The image processing device may also include a generating module configured to generate one or more tissue parameter maps using the respective plurality of estimated tissue parameter values.

In some embodiments, the data collection device may include an MRI device configured to acquire the undersampled k-space data. In other embodiments, the image processing device may include at least one processor configured to execute computer-readable instructions to cause a computing device to perform functions including acquiring the undersampled k-space data, estimating the one or more tissue parameter values, and generating of the one or more tissue parameter maps.

In yet another aspect, a method for tissue parameter mapping is disclosed. In some exemplary embodiments, the method may include receiving undersampled k-space data corresponding to a dynamic physiological process in an area of interest of a subject. The method may also include estimating, from the undersampled k-space data, one or more respective tissue parameter values representing a respective state of the dynamic process at each point in time of a predetermined plurality of points in time during the acquisition. The estimation may include unscented Kalman filtering. The method may further include generating one or more tissue parameter maps using the respective plurality of estimated tissue parameter values.

In some embodiments, the one or more tissue parameter values may include one or more of T1, T2, T2*, perfusion parameter (e.g., cerebral blood flow, mean transit time, arterial transit time, myocardial blood flow), or diffusion parameter (e.g., apparent diffusion coefficient) values, and the one or more tissue parameter maps may include one or more of T1, T2, T2*, perfusion parameter, and diffusion parameter maps. The estimation may include simultaneously estimating a plurality of the tissue parameter values. Further, receiving the undersampled k-space data may include acquiring the undersampled k-space data using an MRI device.

In another aspect, a non-transitory computer-readable medium is disclosed. In some exemplary embodiments, the non-transitory computer-readable medium may have stored computer-executable instructions that, when executed by one or more processors, cause a computer to perform functions that include receiving undersampled k-space data corresponding to a dynamic physiological process in an area of interest of a subject. The functions may also include estimating, from the undersampled k-space data, one or more respective tissue parameter values representing a respective state of the dynamic process at each point in time of a predetermined plurality of points in time during the acquisition. The estimation may include unscented Kalman filtering. Further, the functions may include generating one or more tissue parameter maps using the respective plurality of estimated tissue parameter values.

In some embodiments, the one or more tissue parameter values may include one or more of T1, T2, T2*, perfusion parameter (e.g., cerebral blood flow, mean transit time, arterial transit time, myocardial blood flow), or diffusion parameter (e.g., apparent diffusion coefficient) values, and the one or more tissue parameter maps may include one or more of T1, T2, T2*, perfusion parameter, and diffusion parameter maps. The estimation may include simultaneously estimating a plurality of the tissue parameter values. Further, receiving the undersampled k-space data may include acquiring the undersampled k-space data using an MRI device.

In the following description, references are made to the accompanying drawings that form a part hereof and that show, by way of illustration, specific embodiments or examples. In referring to the drawings, like numerals represent like elements throughout the several figures.

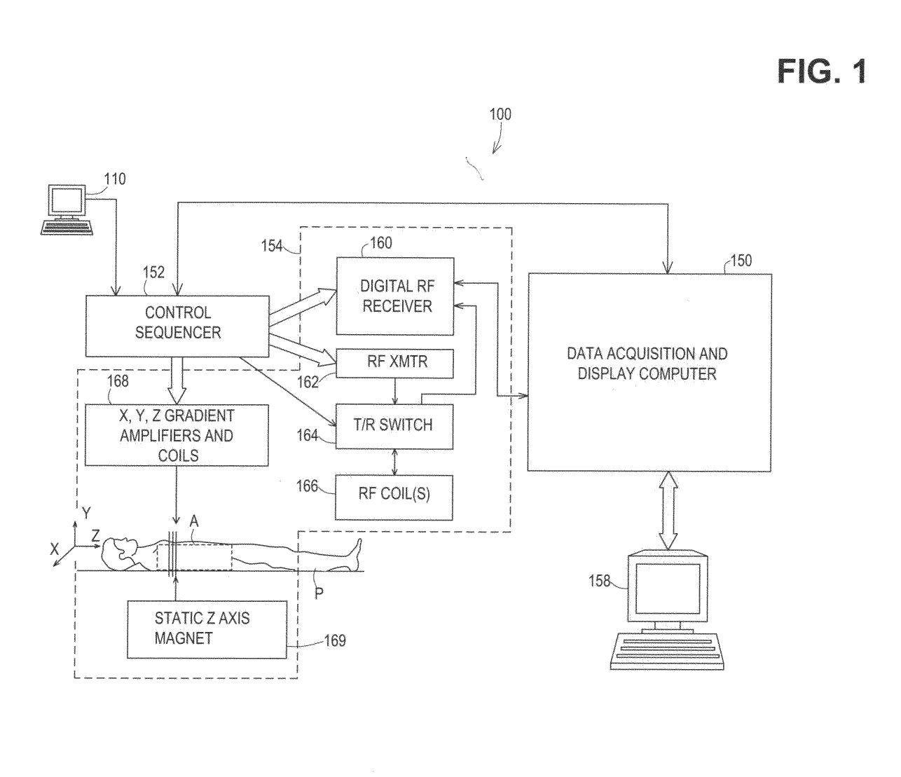

FIG. 1 is a system diagram illustrating an imaging system capable of implementing aspects of the present disclosure in accordance with one or more exemplary embodiments. FIG. 1 illustrates an example of a magnetic resonance imaging (MRI) system 100, including a data acquisition and display computer 150 coupled to an operator console 110, an MRI real-time control sequencer 152, and an MRI subsystem 154. The MRI subsystem 154 may include XYZ magnetic gradient coils and associated amplifiers 168, a static Z-axis magnet 169, a digital RF transmitter 162, a digital RF receiver 160, a transmit/receive switch 164, and RF coil(s) 166. The MRI subsystem 154 may be controlled in real time by control sequencer 152 to generate magnetic and radio frequency fields that stimulate magnetic resonance phenomena in a living subject, patient P, to be imaged. A contrast-enhanced image of an area of interest A of the patient P may be shown on display 158. The display 158 may be implemented through a variety of output interfaces, including a monitor, printer, or data storage.

The area of interest A corresponds to a region associated with one or more physiological activities in patient P. The area of interest shown in the example embodiment of FIG. 1 corresponds to a chest region of patient P, but the area of interest for purposes of implementing aspects of the disclosure presented herein is not limited to the chest area. It should be recognized and appreciated that the area of interest can be one or more of a brain region, heart region, and upper or lower limb regions of the patient P, for example. Physiological activities that may be analyzed by methods and systems in accordance with various embodiments of the present disclosure may include, but are not limited to, muscular movement or fluid flow in particular areas of interest.

It should be appreciated that any number and type of computer-based medical imaging systems or components, including various types of commercially available medical imaging systems and components, may be used to practice aspects of the present disclosure. Systems as described herein with respect to exemplary embodiments are not specifically limited to MRI implementations or the particular system shown in FIG. 1.

One or more data acquisition or data collection steps as described herein in accordance with one or more embodiments may include acquiring, collecting, receiving, or otherwise obtaining data such as imaging data corresponding to an area of interest. By way of example, data acquisition or collection may include acquiring data via a data acquisition device, receiving data from an on-site or off-site data acquisition device or from another data collection, storage, or processing device. Similarly, data acquisition or data collection devices of a system in accordance with one or more embodiments of the present disclosure may include any device configured to acquire, collect, or otherwise obtain data, or to receive data from a data acquisition device within the system, an independent data acquisition device located on-site or off-site, or another data collection, storage, or processing device.

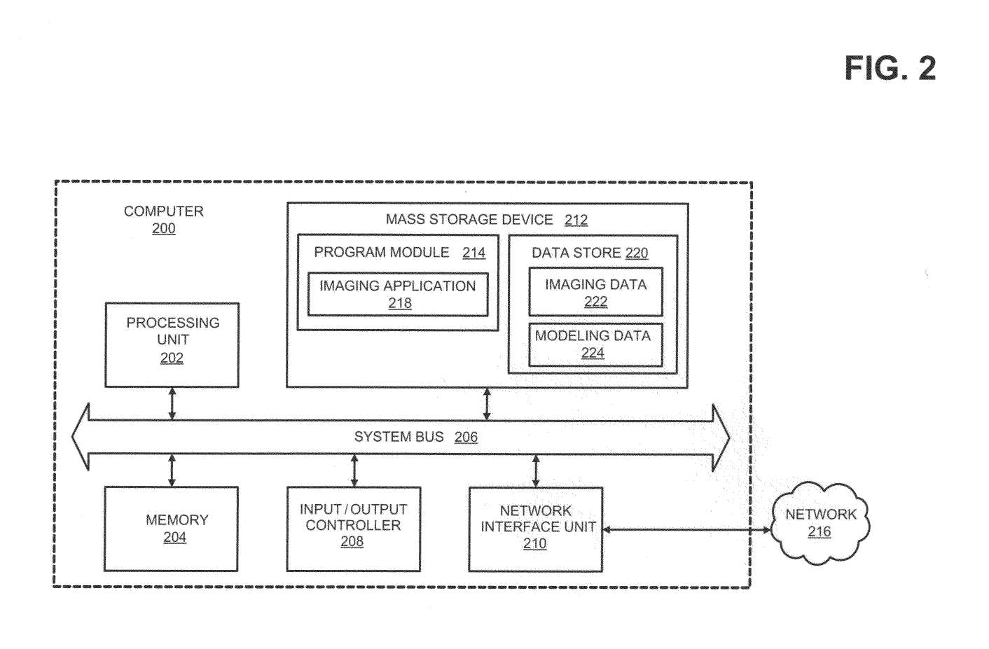

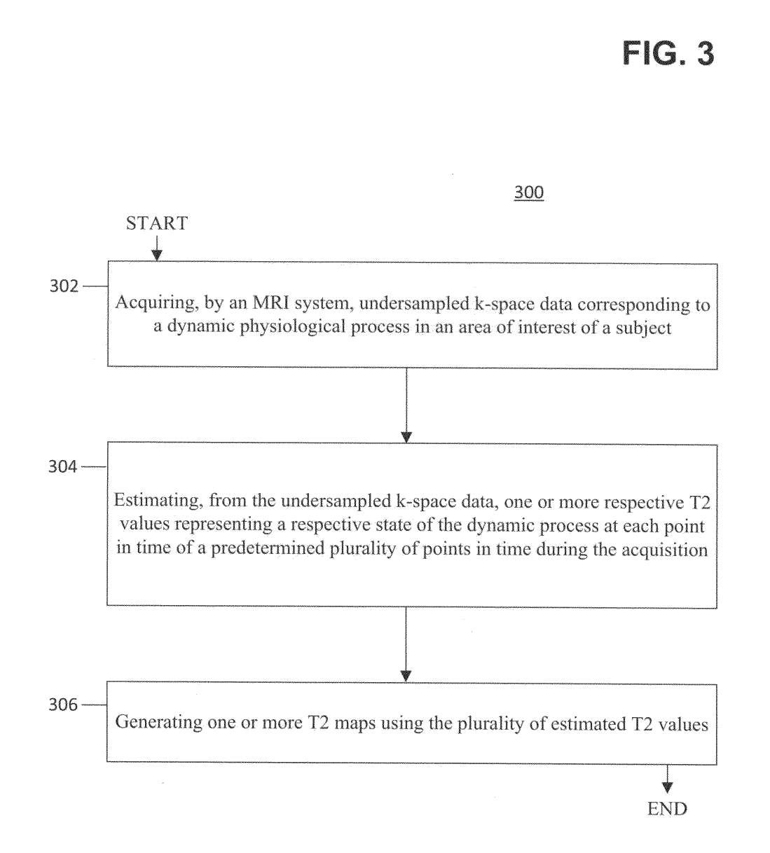

FIG. 2 is a computer architecture diagram showing a general computing system capable of implementing aspects of the present disclosure in accordance with one or more example embodiments described herein. A computer 200 may be configured to perform one or more functions associated with embodiments illustrated in one or more of FIGS. 3-5. For example, the computer 200 may be configured to perform one or more of steps of a disclosed T2 mapping or other tissue parameter mapping process. It should be appreciated that the computer 200 may be implemented within a single computing device or a computing system formed with multiple connected computing devices. The computer 200 may be configured to perform various distributed computing tasks, which may distribute processing and/or storage resources among the multiple devices. The data acquisition and display computer 150 and/or operator console 110 of the system shown in FIG. 1 may include one or more systems and components of the computer 200.

As shown, the computer 200 includes a processing unit 202 (“CPU”), a system memory 204, and a system bus 206 that couples the memory 204 to the CPU 202. The computer 200 further includes a mass storage device 212 for storing program modules 214. The program modules 214 may be operable to perform one or more functions associated with embodiments illustrated in one or more of FIGS. 3-5 discussed below. The program modules 214 may include an imaging application 218 for handling image data acquisition, receipt, and/or processing, or for directing an imaging device in communication with the computer to acquire and/or send image data. The computer 200 can include a data store 220 for storing data that may include imaging-related data 222 such as acquired image data, and a modeling data store 224 for storing image modeling data, or other various types of data utilized in practicing aspects of the present disclosure.

The mass storage device 212 is connected to the CPU 202 through a mass storage controller (not shown) connected to the bus 206. The mass storage device 212 and its associated computer-storage media provide non-volatile storage for the computer 200. Although the description of computer-storage media contained herein refers to a mass storage device, such as a hard disk or CD-ROM drive, it should be appreciated by those skilled in the art that computer-storage media can be any available computer storage media that can be accessed by the computer 200.

By way of example, and not limitation, computer-storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 200. Transitory signals are not “computer-storage media”, “computer-readable storage medium” or “computer-readable storage media” as described herein.

According to various embodiments, the computer 200 may operate in a networked environment using connections to other local or remote computers through a network 216 via a network interface unit 210 connected to the bus 206. The network interface unit 210 may facilitate connection of the computing device inputs and outputs to one or more suitable networks and/or connections such as a local area network (LAN), a wide area network (WAN), the Internet, a cellular network, a radio frequency network, a Bluetooth-enabled network, a Wi-Fi enabled network, a satellite-based network, or other wired and/or wireless networks for communication with external devices and/or systems. The computer 200 may also include an input/output controller 208 for receiving and processing input from a number of input devices. Input devices may include one or more of keyboards, mice, stylus, touchscreens, microphones, audio capturing devices, or image/video capturing devices. An end user may utilize such input devices to interact with a user interface, for example a graphical user interface, for managing various functions performed by the computer 200.

The bus 206 may enable the processing unit 202 to read code and/or data to/from the mass storage device 212 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information. The program modules 214, which include the imaging application 218, may include instructions that, when loaded into the processing unit 202 and executed, cause the computer 200 to provide functions associated with embodiments illustrated in FIGS. 3-5. The program modules 214 may also provide various tools or techniques by which the computer 200 may participate within the overall systems or operating environments using the components, flows, and data structures discussed throughout this description.

In general, the program modules 214 may, when loaded into the processing unit 202 and executed, transform the processing unit 202 and the overall computer 200 from a general-purpose computing system into a special-purpose computing system. The processing unit 202 may be constructed from any number of transistors or other discrete circuit elements, which may individually or collectively assume any number of states. More specifically, the processing unit 202 may operate as a finite-state machine, in response to executable instructions contained within the program modules 214. These computer-executable instructions may transform the processing unit 202 by specifying how the processing unit 202 transitions between states, thereby transforming the transistors or other discrete hardware elements constituting the processing unit 202.

Encoding the program modules 214 may also transform the physical structure of the computer-storage media. The specific transformation of physical structure may depend on various factors, in different implementations of this description. Examples of such factors may include, but are not limited to the technology used to implement the computer-storage media, whether the computer storage media are characterized as primary or secondary storage, and the like. For example, if the computer-storage media are implemented as semiconductor-based memory, the program modules 214 may transform the physical state of the semiconductor memory, when the software is encoded therein. For example, the program modules 214 may transform the state of transistors, capacitors, or other discrete circuit elements constituting the semiconductor memory.

As another example, the computer-storage media may be implemented using magnetic or optical technology. In such implementations, the program modules 214 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

FIG. 3 illustrates operational steps of a method 300 for T2 mapping, according to an exemplary embodiment of the present disclosure. The method 300 may begin at block 302, where an MRI system may acquire undersampled k-space data corresponding to a dynamic physiological process in an area of interest of a subject. At block 304, the method 300 may include estimating, from the undersampled k-space data, one or more respective T2 values representing a respective state of the dynamic process at each point in time of a predetermined plurality of points in time during the acquisition. Then, at block 306, the method 300 may include generating one or more T2 maps using the plurality of estimated T2 values.

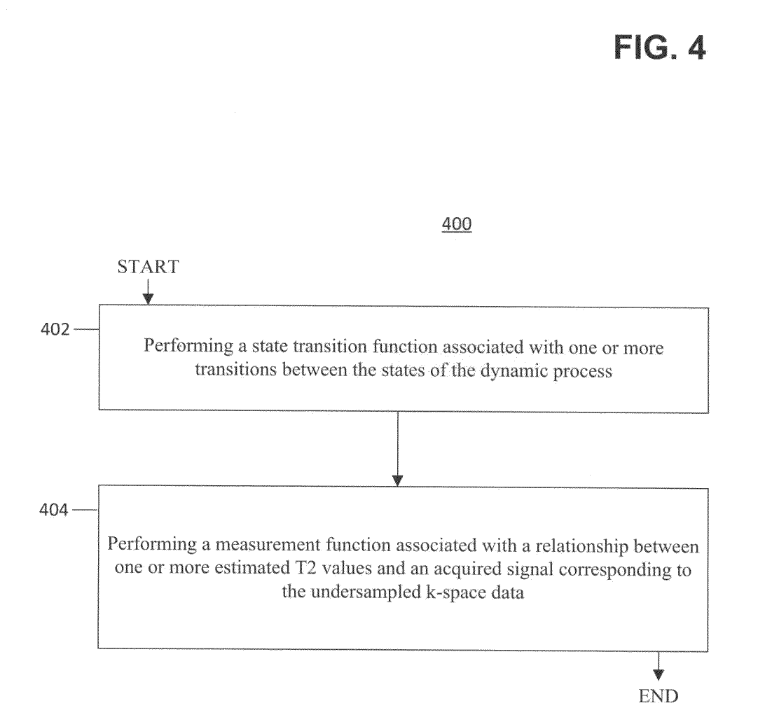

In some embodiments, the estimation block 304 of method 300 may include unscented Kalman filtering. For example, in one embodiment, the method 300 may also include an exemplary unscented Kalman filtering method 400, as shown in FIG. 4. The method 400 may include performing a state transition function associated with one or more transitions between the states and the dynamic process, as shown at block 402. Then, at block 404, the method 400 may include performing a measurement function associated with a relationship between one or more estimated T2 values and an acquired signal corresponding to the undersampled k-space data.

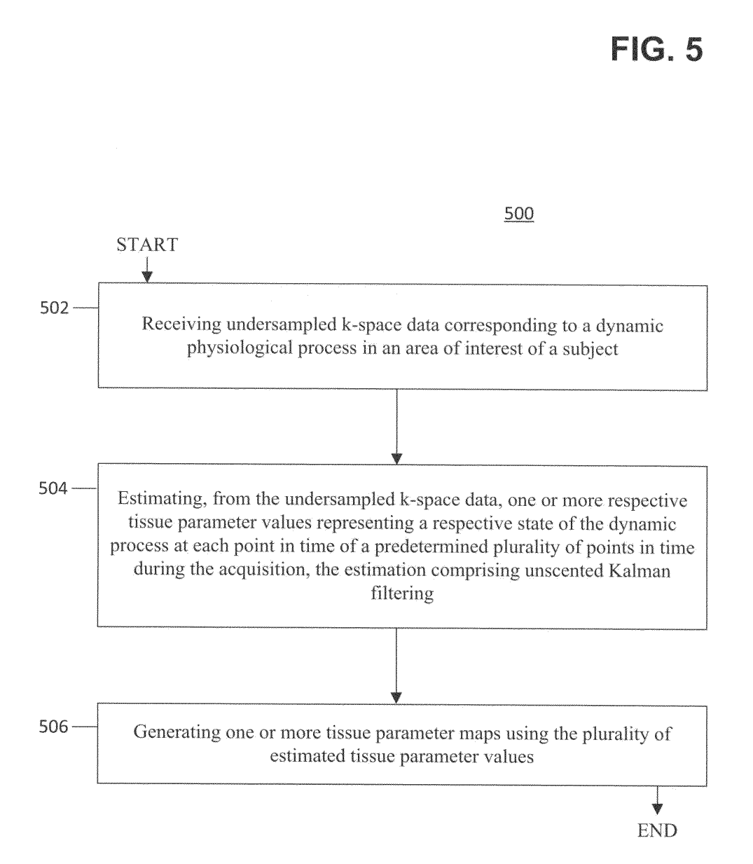

FIG. 5 illustrates operational steps of a method 500 for tissue parameter mapping, according to an exemplary embodiment of the present disclosure. It is contemplated that the method 500 may be used for mapping any tissue parameter, including, but not limited to, T1, T2, T2*, perfusion parameter (e.g., cerebral blood flow, mean transit time, arterial transit time, myocardial blood flow), and diffusion parameter (e.g., apparent diffusion coefficient) mapping. The method 500 may begin by receiving undersampled k-space data corresponding to a dynamic physiological process in an area of interest of a subject, as shown at block 502. For example, in some embodiments, an MRI system may acquire the undersampled k-space data, and send it to a system executing method 500. At block 504, the method 500 may include estimating, from the undersampled k-space data, one or more respective tissue parameter values representing a respective state of the dynamic process at each point in time of a predetermined plurality of points in time during the acquisition. The estimation may include unscented Kalman filtering. Then, at block 506, the method 500 may include generating one or more tissue parameter maps using the plurality of estimated tissue parameter values.

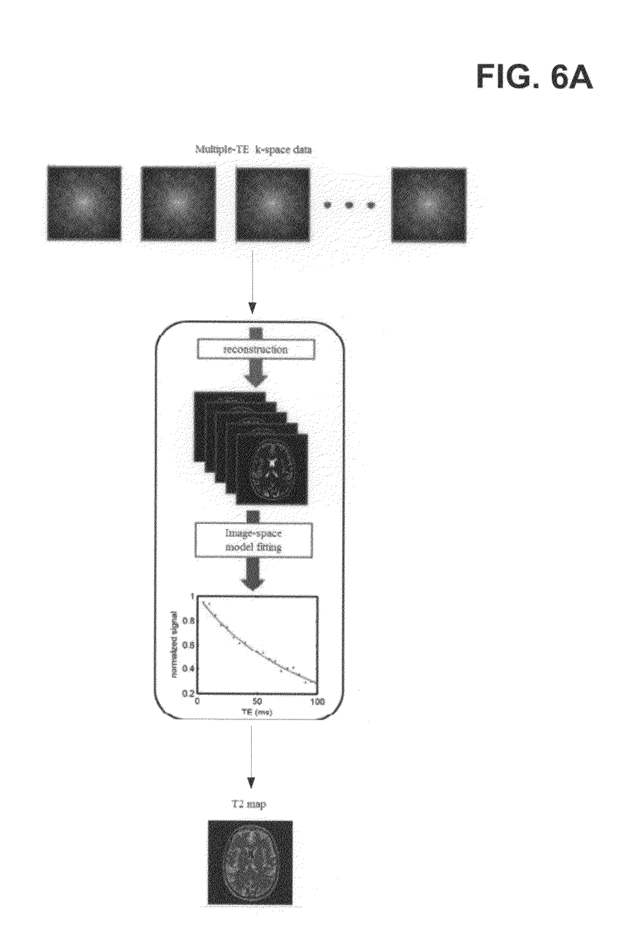

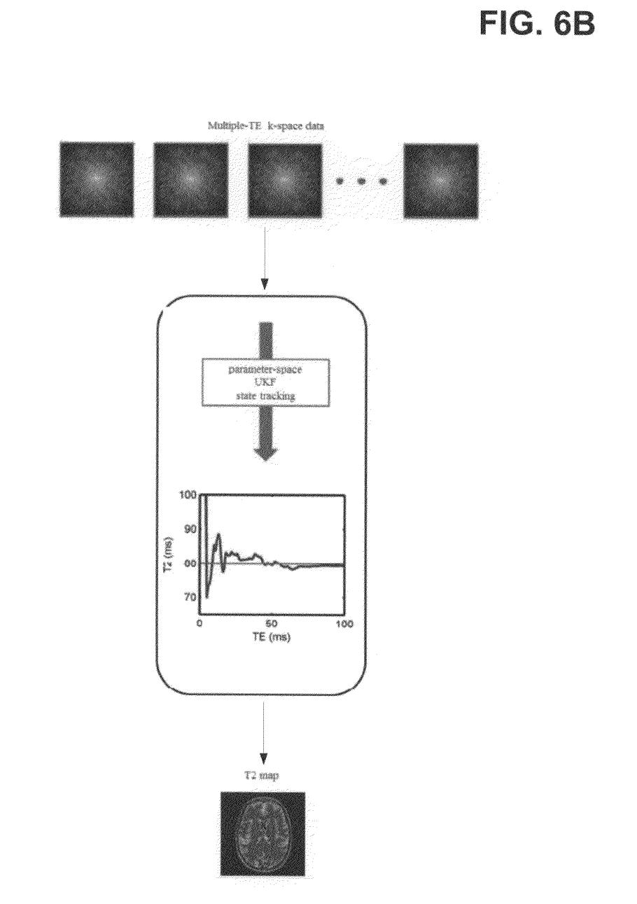

FIG. 6A illustrates a T2 mapping process for reconstructing T2-weighted images from k-space data, as conventionally used with multiple-TE measurements. The intensity of each pixel (blue dots) is regressed to the signal decay model (red line) and results in the local T2 value. In contrast, the exemplary embodiment of the disclosed method for T2 mapping shown in FIG. 6B may track the T2 value in parameter-space using a UKF, and produce the T2 map directly from the k-space data. The red line indicates the true T2 value. The blue line illustrates the tracking process, which approaches the true T2 value as more measurements are included.

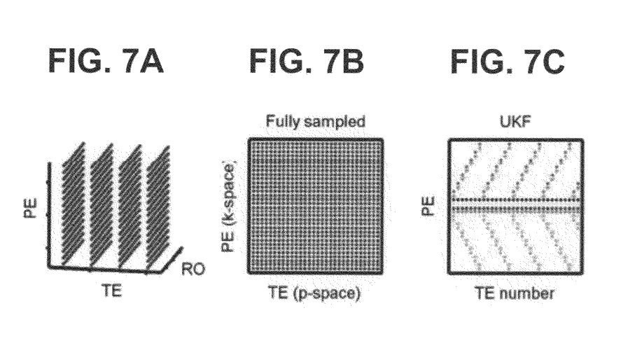

FIGS. 7A and 7B illustrate aspects of fully sampled T2 data sampling patterns in k-p-space, in accordance with an example embodiment of the present disclosure. In FIGS. 7A and 7B, data is always fully sampled in the readout direction. FIG. 7C illustrates an undersampling T2 data sampling pattern for an exemplary embodiment of the disclosed T2 mapping method using a UKF with an acceleration rate 4. The color of each dot in FIG. 7C indicates phase encoding lines that are collected during the same echo train when using the accelerated pulse sequence. Four of the echo trains (black, yellow, blue, and pink dots) collect fully-sampled data at the center of k-space by collecting the same phase encoding at each echo. The other four echo trains collect undersampled data in the outer region of k-space, cycling through a set of phase encodings.

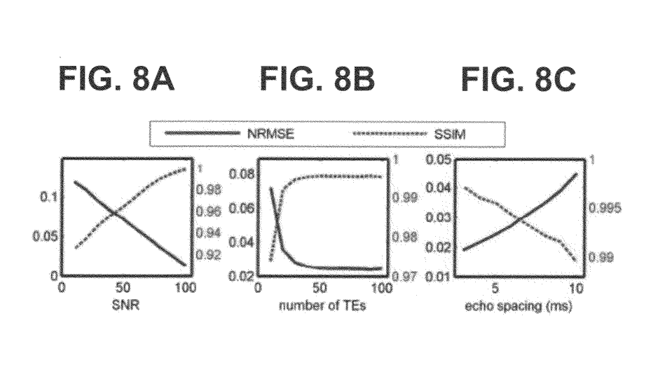

FIGS. 8A-C show aspects of performance of an exemplary embodiment of the disclosed method for T2 mapping using a UKF (hereinafter “UKF Method”) as a function of SNR, number of encoding states, and echo spacing, respectively. Specifically, error is shown as normalized root-mean-square error (“NRMSE”) in blue, and the structural similarity index (“SSIM”) is shown in green. As shown in FIG. 8A, higher signal-to-noise ratio (“SNR”) improves structural similarity and lowers estimation error. As shown in FIG. 8B, introducing more measurements improves the T2 map estimate, but limited improvement is seen beyond 70 measurements. As shown in FIG. 8C, with constant echo train length and noise level, large echo spacing resulted in low SNR and reduced accuracy of T2 estimation.

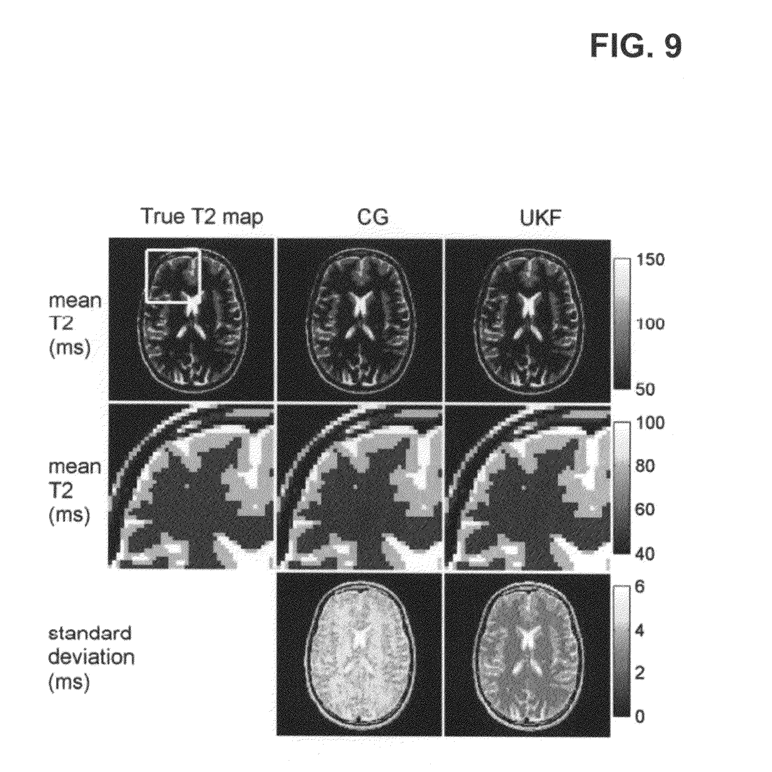

FIG. 9 shows T2 estimation in Monte Carlo simulations with a nonlinear inversion method (hereinafter “CG Method”) and an embodiment of the UKF Method. The top row shows the true T2 map and the mean T2 maps from 100 Monte Carlo simulations of the two methods with an acceleration rate of 8. The middle row shows zoomed-in views of the maps. The bottom row shows the standard deviation of the Monte Carlo simulations for the two methods. The color bar on the right side of FIG. 9 indicates T2 and standard deviation in milliseconds (“ms”). Both methods demonstrate good accuracy and minimal blurring, and the embodiment of the UKF Method has superior precision.

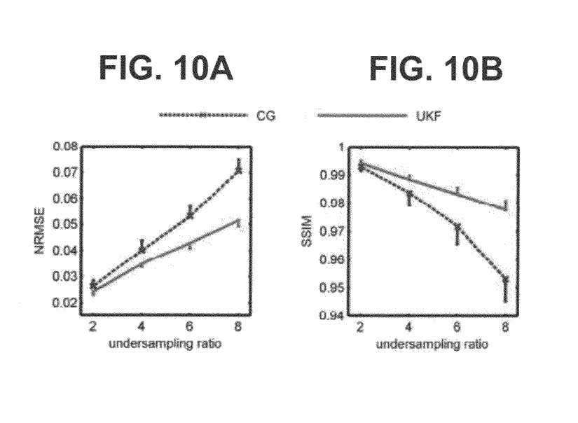

FIGS. 10A and 10B show quantification of the error in the estimated T2 maps from a simulation. With acceleration rates of 2, 4, 6 and 8, an embodiment of the UKF Method (red) estimation results in lower NRMSE (left) and higher SSIM (right) than the CG Method (blue). It also provided stable performance with lower variance (×5).

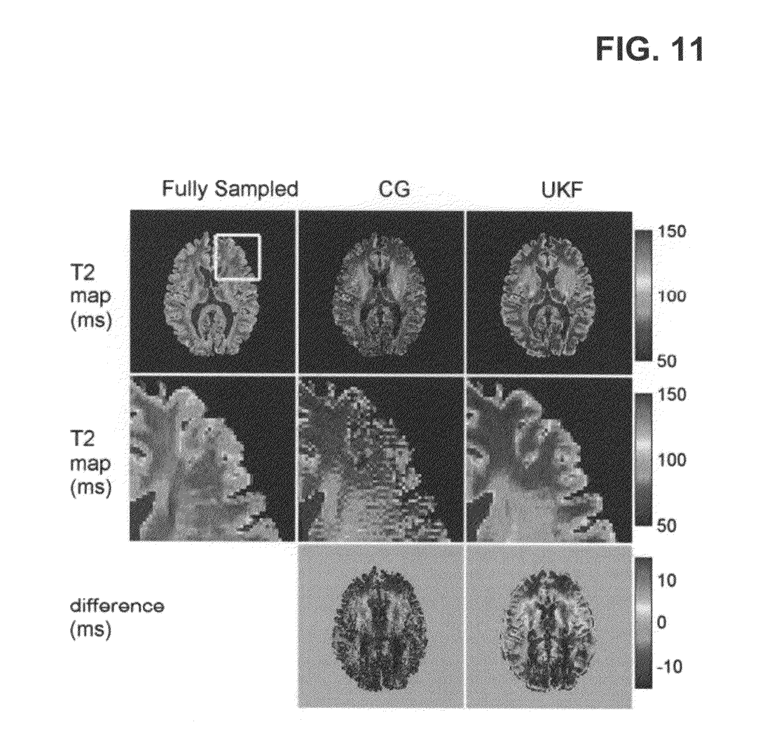

FIG. 11 shows T2 maps from the CG method and a two-parameter embodiment of the UKF Method from a volunteer scan in the top row. In the middle row, FIG. 11 includes zoomed-in views of the T2 maps. With a retrospective undersampling factor of 8, the expected loss of SNR was the principal difference with the fully sampled map. The two methods resulted in similar regions of estimation error, but the CG Method resulted in higher noise. Error maps calculated by comparison with fully sampled data are shown in the bottom row. The color bars for the T2 and error maps are in ms.

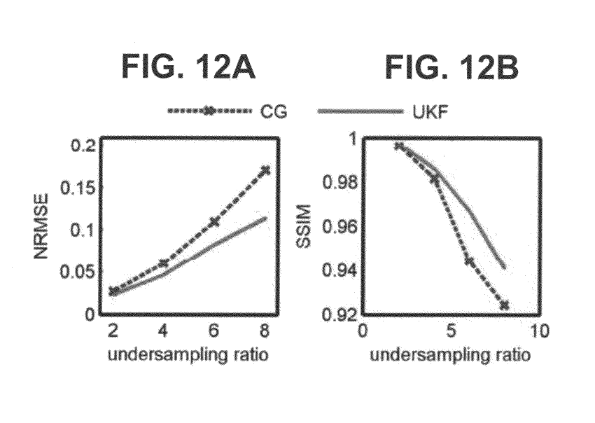

FIG. 12 shows estimation errors with retrospectively undersampled volunteer data at various undersampling ratios for the CG Method (blue) and an embodiment of the UKF Method (red). The UKF method resulted in more accurate estimation than the nonlinear inversion method with lower NRMSE (left) and higher SSIM (right).

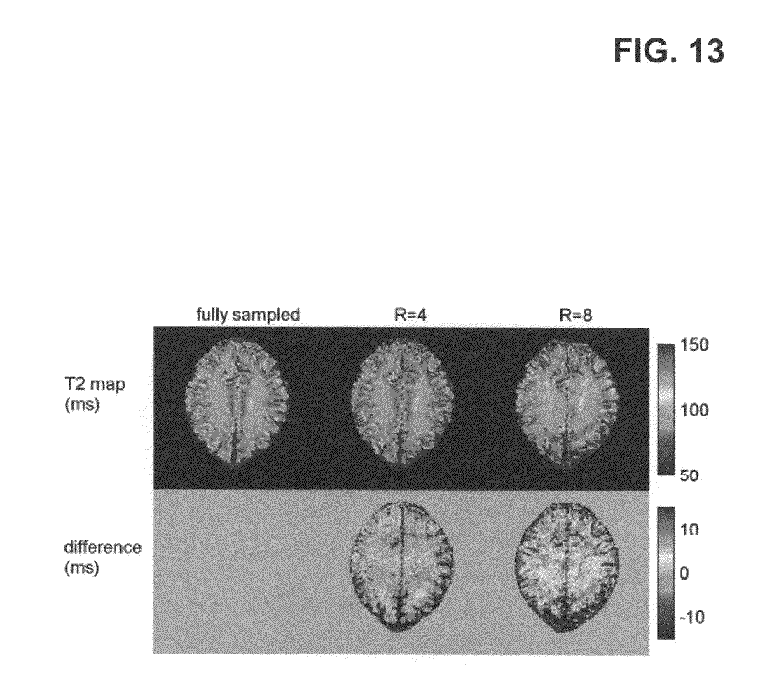

FIG. 13 shows performance of an embodiment of the UKF method with accelerated acquisition. Compared with the T2 map from fully sampled k-space data (left), the embodiment of the two-parameter UKF method provided T2 maps with negligible differences at acceleration rate 4 (middle) and acceleration rate 8 (right). The color bars for the T2 maps and error maps are in ms.

### Example Implementations and Results

The following describes examples of implementing some aspects of the present disclosure, and corresponding results.

### Methods

Kalman Filter

The Kalman filter (21) is a recursive and efficient method for estimating the state of a system from noisy measurements, and it is optimal in the maximum likelihood sense for a Gaussian noise model. The Kalman filter describes a dynamic system using two equations: the state transition equation describes the evolution of the underlying system, and the measurement equation describes how the measurements of the system are related to the system state. The system state may be updated recursively based on the measurements. The general Kalman filter can be expressed as follows:

xₖ=ƒ(xₖ₋₁,wₖ₋₁)

zₖ=h(xₖ,νₖ)

p(w)˜N(0,Q)

p(ν)˜N(0,R) [1]

where ƒ is the state transition function; xₖ is the k^{th} state of system; wₖ₋₁ is the system noise, assumed to be white Gaussian noise with covariance matrix Q; h is the measurement function of state xₖ; zₖ is the measured data; νₖ is the measurement noise, also assumed to be white Gaussian noise with covariance matrix R; and k is the state index.

T2 Decay Model in the Kalman Filter

For the special case of T2 mapping, the signal decay at a rate of T2 in p-space can be observed. In this case, the T2 map can be chosen as the system state, which is assumed to be constant in time, and let k be the index of each TE measurement. Therefore, the state transition function is

ƒ(xₖ₋₁,wₖ₋₁)=xₖ₋₁+wₖ₋₁ [2]

The measurement function h(xₖ,νₖ) describes the relationship between T2 and the acquired signal:

h(xₖ,νₖ)=UₖFSM(tₖ,xₖ)+νₖ [3]

where Uₖ is an undersampling pattern at the k^{th} state, F is a Fourier transform operator and S is a coil sensitivity map. M(tₖ,xₖ) is the T2 weighted image at the k^{th} state:

$$M ( {t}_{k} , {x}_{k} ) = ρ {e}^{- \frac{{t}_{k}}{T 2}} \qquad [ 4 ]$$

where tₖ is the echo time (“TE”).
With constant echo spacing, the T2 weighted signal can be simplified as follows:

$$M ( k ) = {ρ ( {x}_{k} )}^{k} , k - 0 , 1 , 2 , … , K \\ {x}_{k} = exp ( - \frac{Δ t}{T 2} ) \qquad [ 5 ]$$

Here, the shortest TE measurement from k=1 is treated, so M(1)=ρe^{-Δt/T2}. When the shortest TE is equal to the echo spacing Δt, ρ is then a proton density image. When the shortest TE is longer than Δt, ρ is a T2 weighted image. K is the echo train length.

Given the state transition function ƒ and measurement function h, the Kalman filter estimation problem is now defined. The system state xₖ—the desired T₂ map— can be estimated by the UKF, as described in the following section.

Unscented Kalman Filter (“UKF”)

The basic Kalman filter uses linear state transition and measurement functions. It can be adapted to nonlinear models using various approximations. An early version of this approach was the extended Kalman filter (EKF), which linearizes the filter using a Jacobian matrix. The EKF has limited accuracy for highly nonlinear problems. The UKF represents the nonlinear model by the unscented transform, follows the state distribution using a deterministic sampling approach and achieves higher order approximation of the measurement.

The main difference between the UKF and the conventional Kalman filter is that the UKF does not use the T2 map directly in the tracking process, but instead generates a series of states around the target T2 state to represent its behavior in the dynamic system. This series of states are called sigma vectors χᵢ and they are generated according to the variance of the T2 state:

$${χ}_{k - 1 , i} = \{ \begin{matrix}{x}_{k - 1} & if i = 0 \\ {x}_{k - 1} + {T}_{i} , & if i = 1 , … , N \\ {x}_{k - 1} - {T}_{i} , & if i = N + 1 , … , 2 N\end{matrix} \qquad [ 6 ]$$

where N is the dimension of the T2 state and Tᵢ is the i^{th} column of the matrix square root of the covariance matrix (N+λ)Pₖ₋₁:

TT′=(N+λ)Pₖ₋₁ [7]

λ is a scaling factor and α=0.01 describes the distance between xₖ₋₁ and the generated sigma vectors:

λ=a²N−N [8]

As with xₖ₋₁, the sigma vectors χ_{k-1,i} propagate from the previous TE measurement to the current TE measurement by the function ƒ:

χ_{k,i}=χ_{k-1,i} [9]

Each sigma vector χ_{k,i} is measured, which yields the k-space signal Σ_{k,i}:

ζᵢ=UₖFρe^{-k}^{_{χk,i}} [10]

The estimated state xₖ⁻ is represented by a combination of the current sigma vectors:

xₖ⁻=Σᵢ₌₀^{2N}wᵢ^{m}χ_{k,i} [11]

The measured signal z is estimated by a combination of Σ:

$$\begin{matrix}{z}_{k}^{-} = {\sum }_{i = 0}^{2 N} {w}_{i}^{m} {ζ}_{k , i} where & [ 12 ] \\ {w}_{i}^{m} = \{ \begin{matrix}\frac{λ}{λ + N} & if i = 0 \\ \frac{0.5}{λ + N} & if i = 1 , … , 2 N\end{matrix} & [ 13 ]\end{matrix}$$

The difference between the acquired data zₖ and estimated data zₖ⁻ is updated to correct the prediction in the next state xₖ:

xₖ=xₖ⁻+G(zₖ−zₖ⁻) [14]

G is the gain matrix and it is expressed as

$$\begin{matrix}G = {P}_{xz} {P}_{z}^{- 1} \\ where & [ 15 ] \\ {P}_{z} = {\sum }_{i = 0}^{2 N} {w}_{i}^{c} ( {ζ}_{i} - {z}_{k}^{-} ) {( {ζ}_{i} - {z}_{k}^{-} )}^{′} + R & [ 16 ] \\ {P}_{xz} = {\sum }_{i = 0}^{2 N} {w}_{i}^{c} ( {χ}_{k , i} - {x}_{k}^{-} ) {( {ζ}_{i} - {z}_{k}^{-} )}^{′} & [ 17 ] \\ {w}_{i}^{c} = \{ \begin{matrix}\frac{λ}{λ + N} + 1 + {α}^{2} + β , & if i = 0 \\ \frac{0.5}{λ + N} , & if i = 1 , … , 2 N\end{matrix} & [ 18 ]\end{matrix}$$

β describes the prior knowledge of x. β=2 is optimal for a Gaussian distribution (22). The covariance matrix Pₖ estimates the error of current state xₖ:

Pₖ⁻=Σᵢ₌₀^{2N}wᵢ^{c}(χ_{k,i}−xₖ⁻)(χ_{k,i}−xₖ⁻)′+Q [19]

Pₖ=Pₖ⁻GP_{z}G′ [20]

The above steps (Eqs. 6-20) may proceed recursively until all the measurements are included.

Two Parameter Estimation

The embodiment of the UKF Method described above may be referred to as a single-parameter UKF method because it estimates a T2 map with the assumption that ρ is known. A pre-scan to obtain a ρ map is feasible, but this requires additional scan time and could introduce measurement error. ρ can be incorporated into the estimated state, doubling the number of variables to be estimated and increasing the computational complexity. This can be referred to as a two-parameter UKF method as referred to herein. In the two-parameter UKF method, Eq. 2 becomes:

$$f ( [ \begin{matrix}{x}_{k - 1} \\ {ρ}_{k - 1}\end{matrix} ] , [ \begin{matrix}{w}_{x , k - 1} \\ {w}_{ρ , k - 1}\end{matrix} ] ) = [ \begin{matrix}{x}_{k - 1} \\ {ρ}_{k - 1}\end{matrix} ] + [ \begin{matrix}{w}_{x , k - 1} \\ {w}_{ρ , k - 1}\end{matrix} ] \qquad [ 21 ]$$

As for the single-parameter UKF method, it can be assumed that the minimum TE map ρ is constant in time.

### Parameter Initialization

To reduce the size of the covariance matrix in the calculations, the image pixels may first be localized using a 1D Fourier transform along the readout direction, as in Feng et al. (18). The minimum TE weighted ρ map is initialized by the measurement with the shortest TE in the UKF method. The T2 map may be empirically initialized to a constant value, such as 80 ms.

Here it can be assumed that the estimated T2 map is real and the phase information is included in sensitivity maps, as in parallel image reconstruction with SENSE (9). Sensitivity maps may be calculated from fully sampled k-space data. In some embodiments of the UKF Method, it may be assumed that sensitivity maps are provided as prior knowledge. In other embodiments, the UKF Method may instead estimate an accurate sensitivity map in accordance with known methods.

The initial estimation error covariance matrix P₀ may be empirically chosen as a diagonal matrix proportional to the noise level σ² of the measured image, and the matrix is updated with each TE measurement. The inaccuracy in P₀ is thus corrected as more TE measurements are included.

The distribution of noise ν may be assumed to be a stationary process, which does not change during the scan. Its covariance matrix R becomes a diagonal matrix with each diagonal element equal to σ²I in the case of white Gaussian noise. This assumption is likely to be more reliable for T2 measurements of the brain than of the heart, because there is less motion and change in volume. There should be little change between each state in T2. To simplify the calculation, it may be assumed that the noise from the multiple channels ν₁, . . . , νₙ follow the same distribution R. However, a small Q may be empirically chosen to stabilize the estimation. Tuning the parameters Q and R can improve the performance of the UKF.

Simulations

A realistic analytical phantom (23) was used to simulate the acquisition, reconstruction and parameter estimation process. The brain was divided into four regions-of-interest (ROIs) with T2s of 50, 80, 120 and 250 ms. The proton density M₀ was normalized to 1. To simulate the multiple-TE measurements, 70 parameter encoding states were generated with echo spacing equal to 5 ms. These images were sampled by a Cartesian trajectory with a matrix size of 128×128 with receiver phase following the Biot-Savart law (23). The generated data was contaminated by additive white Gaussian noise. SNR was defined according to the T2 weighted image with the shortest TE measurement.

To evaluate the sensitivity of the proposed method to changes in experimental conditions, estimated T2 maps were evaluated while varying the noise level, the number of echoes, and the echo spacing. For these simulations, the data was fully sampled. In the noise tolerance test, T2 mapping acquisitions were simulated with echo spacing 5 ms, 70 echoes, and SNR varying from 10 to 100. In the test of the number of echoes, the acquisitions were simulated with SNR 50, echo spacing 5 ms, and the number of echoes varying from 10 to 100. In the test of echo spacing, the acquisitions were simulated with SNR 50, 32 echoes, and echo spacing varying from 3 ms to 10 ms.

To verify the performance of UKF methods with an accelerated acquisition, k-space data was retrospectively undersampled by factors of 2, 4, 6, and 8 at each TE. Other parameters were SNR 50 and 70 echoes with echo spacing 5 ms. The proposed methods were compared to the nonlinear inversion method of Sumpf et al. (16), which uses a conjugate gradient (CG) method to perform the inversion. The same sensitivity map was provided as prior knowledge for CG and the proposed method. Both methods used the same undersampling pattern. As shown in FIG. 7C, the undersampling pattern includes a few central phase-encoding lines and a few outer k-space lines at each TE. This pattern is designed to contain the same number of phase encoding lines at each TE value, so that it is compatible with a multiple-contrast spin echo pulse sequence. The color of each dot represents data that is acquired during a single echo train.

At SNR 50 (σ=0.02), one hundred realizations of k-space were performed for Monte-Carlo simulations. Independent and identically distributed complex Gaussian noise was generated and added to the k-space data. Each data set was undersampled with acceleration factors 2, 4, 6 and 8, and reconstructed by the proposed method and Sumpf's CG method.

The results were compared with the fully sampled noiseless T2 map and quantified by the structural similarity index (SSIM) (24) and the normalized root of mean squared error (NRMSE) of the gray matter and white matter regions.

Experiments

T2 mapping data with multiple TE measurements were acquired on normal volunteers. All of the experiments were performed on a 3T Siemens Trio scanner with a 12-channel head coil. The study followed a human subject protocol approved by the University of Virginia with written informed consent from each subject.

A modified multiple-contrast spin echo sequence was used to acquire fully sampled data. Each phase encoding was acquired in one echo train at different TEs. The parameters were as follows: TR 2.5 s, slice thickness 5 mm, FOV 220 mm, matrix size 192×192, bandwidth 500 Hz/pixel, 70 spin echoes, and echo spacing of 5.5 ms. The total scan time was approximately 8 minutes.

The volunteer data was retrospectively undersampled by factors of 2, 4, 6 and 8 with the same undersampling scheme used for the simulation. The signal from the first echo was not used, to avoid transient signal variation. The sensitivity map was estimated by combining undersampled data from multiple echoes (16). The UKF method and CG method were used to estimate the T2 and ρ maps. The results were evaluated using SSIM and RMSE by comparison to the standard T2 map, which was obtained from fully sampled data and least squared error model fitting.

To accelerate the acquisition, the undersampling scheme was adapted into a multiple contrast spin echo sequence to achieve prospective undersampling. After excitation, the sequence collected 70 spin echoes with echo spacing of 5 ms, with each echo designed to acquire a phase encoding value selected according to the undersampling scheme. For example, the first echo train collected the highest line in each k-space cluster, shown as the red dots in FIG. 7C. The second echo train collected the green dots and third echo train collected the black dots, and so on. Three experiments were performed: one collected fully sampled k-space and the other two were undersampled prospectively by factors of 4 and 8. Other scan parameters were as follows: TR 2 s, slice thickness 5 mm, FOV 200 mm×200 mm and image matrix size 128×128. With fully sampled k-space, the scan time would have been more than 4 minutes. With the accelerated sequence, the scan times were reduced to about 1 minute and 30 seconds for undersampling factors of 4 and 8, respectively. The sensitivity map was estimated from undersampled data as above and T2 maps were estimated by CG and UKF methods.

The image reconstruction was performed in MATLAB 2012b (The MathWorks, Inc) with a 4×GTX 680 Workstation (Amax Information Technologies, Inc). 12 CPU cores (Intel Xeon E5-2640 2.50 GHz Processor LGA2011) were used for parallel computation.

### Results

Simulations

The accuracy of T2 estimation strongly depends on the SNR of the acquired signal. Compared with the noiseless T2 map, the results in FIG. 8A show that the estimated T2 map has reduced error and increased similarity as the SNR of the acquisition increases. The amount of available data is also essential to the quality of estimation. As shown in FIG. 8B, as the number of TE measurements increases, estimation errors are reduced and structural similarity is increased. Acquiring more than 70 TE measurements may yield limited improvement in T2 map quality. As a result, 70 echoes were used for the experiments described herein. FIG. 8C shows the results with different echo spacing. With constant echo train length, larger echo spacing resulted in low SNR in the late echoes, which reduced the accuracy of T2 estimation.

FIG. 9 shows the results of Monte Carlo simulations of T2 mapping with the nonlinear inversion method and the UKF method. With an acceleration rate of 8, the mean T2 maps (top row) from 100 Monte Carlo simulations had negligible artifacts. Zoomed-in maps (middle row) show that the two methods have similar mean T2 values and that these values are close to those of the true T2 map, which demonstrates that both methods are accurate. There is little spatial blurring of the mean maps with either method. The standard deviation of the estimated T2 maps (bottom row) show that the UKF Method resulted in more stable results than the CG Method and, thus, a more precise estimation of T2.

FIGS. 10A and 10B plot the quantitative results of the nonlinear inversion reconstruction and an embodiment of the UKF Method at acceleration factors of 2-8. Results are shown as the mean and standard deviation (×5) of the Monte-Carlo simulations. The embodiment of the UKF Method resulted in lower NRMSE error and higher similarity index. The embodiment of the UKF Method also provided more stable performance with lower variance, as shown by the error bars.

Experiments

Volunteer results with retrospective undersampling are shown in FIG. 11. As in the simulation results, an embodiment of the UKF Method estimated the T2 map accurately, based on comparison with fully sampled data. At an acceleration rate of 8, T2 maps from both methods had lower SNR and more error at the interfaces between cerebrospinal fluid and gray matter. The two methods show estimation errors in similar regions, which could be partly due to error in the sensitivity map estimation. The map estimated with the CG Method (NRMSE=0.1708) had noticeable noise, as shown in the zoomed-in images along the middle row. The map estimated with an embodiment of the UKF Method had negligible artifacts and lower estimation error (NRMSE=0.1140) than the CG Method.

Quantitative metrics of the retrospectively undersampled T2 maps are shown in FIGS. 12A and 12B. As the acceleration rate increased, the estimation errors increased and structural similarity decreased. An embodiment of the two-parameter UKF Method resulted in lower NRMSE and higher SSIM at each level of undersampling.

FIG. 13 shows T2 maps from accelerated acquisitions with the undersampled sequence. An embodiment of the two-parameter UKF Method recovered T2 maps with undersampling factors of 4 (center) and 8 (right). Compared to the T2 map from fully sampled k-p-space (left), the embodiment of the UKF Method has lower SNR as expected, but few aliasing artifacts and negligible difference overall.

### Discussion

Embodiments of the disclosed UKF Method were applied to estimate parameter maps directly from highly undersampled k-space data. In some embodiments, the UKF Method poses parameter mapping as a state-tracking problem in k-p-space. It uses MR parameters as the fundamental state space and the magnetic resonance (“MR”) signal model as the measurement model. By monitoring the propagation of this dynamic system, the UKF Method may yield quantitative parameter maps directly without image reconstruction. An embodiment of the UKF Method was applied to T2 mapping with undersampled k-space data. It achieved high accuracy in parameter estimation with undersampling factors of 2, 4, 6 and 8. The embodiment of the UKF Method yielded higher precision in simulation and experiment than a direct nonlinear inversion reconstruction. In some embodiments, the UKF Method may be adapted into a multiple-contrast spin echo sequence to achieve prospectively accelerated acquisition, as demonstrated.

While an embodiment of the UKF Method was applied to T2 map estimation in this study, it could apply to other parameter mapping problems, such as T1 mapping with a Look-Locker pulse sequence and T2* in functional MRI (25). Because the Fourier transform operator is linear, the non-linearity of the signal model prior to the Fourier transform is the main limit on the performance of the UKF estimator. While this was not a significant limitation for T2 mapping, it could be more of a limitation for other parameter estimation problems, such as perfusion-weighted imaging.

In some embodiments, the UKF Method can be used to estimate multiple parameters of a model simultaneously, as demonstrated by the tested embodiment of the two-parameter UKF method, where both T2 and ρ were estimated. However, a more complex model could reduce the accuracy of estimation and require more measurements.

The accuracy of parameter estimation may be limited by the number of measured states in p-space. The Kalman filter yields the maximum likelihood estimate, which approaches the minimum variance estimate when the number of encoding states is large enough. Acquiring more measurements along p-space may increase the estimation accuracy. However, the number of TE measurements in a multiple contrast spin echo sequence may be limited by the readout bandwidth and SNR. The measurements with long TE may be noisy and yield limited improvement of the estimate. The number of measurements in p-space can also be limited by the specific application and available scan time.

An alternate way to improve estimation accuracy may be to improve the convergence of the UKF estimator. The first few iterations of a Kalman filter train the covariance P. A small initial P₀ can stabilize the propagation of the covariance matrix P and can also constrain the estimated values to be near the initial values. More accurate initialization of the T2 and ρ could help with convergence, although this may slow down the training of the covariance matrix.

The directly estimated T2 map may be a real image, rather than a complex image as in conventional image reconstruction. In the disclosed experiments, it was assumed that the phase of the image is contained in the sensitivity maps and is constant with TE, so that the phase of the images at different echo times can be removed and later recovered using the sensitivity maps. When using multiple channel data, some embodiments of the UKF Method may adopt the features of SENSE parallel image reconstruction, which helps to improve the quality of the estimated parameter map. In a single coil measurement, embodiments of the UKF Method may perform better with a sensitivity map, because it provides phase information for data fidelity. The accuracy of the sensitivity map will directly affect the accuracy of the estimated T2 map. It should be possible to add sensitivity estimation to the UKF model, which would enable simultaneous estimation of a sensitivity map and a T2 map. However, this would also significantly increase the estimation complexity.

The accuracy of the estimated T2 map also depends on pulse sequence design. The multiple contrast spin echo sequence is time efficient compared to a conventional spin echo sequence, but acquired signal includes multiple signal pathways, which mixes stimulated echoes and indirect echoes (26-28). Therefore, the T2 signal is not accurately modeled by a mono-exponential T2 decay model. The accuracy is also limited by the performance of refocusing RF pulses (29). Additionally, in fully sampled k-p-space, the same phase encoding lines are acquired in one excitation, but in undersampled k-p-space some of the phase encoding lines may be acquired in different echo trains. The order of phase encoding lines could introduce more variation in the quantification of the T2 map. It is contemplated that additional improvements to the disclosed embodiments of the UKF Method are possible with better sequence design.

The 1D simplification achieved by performing a 1D Fourier transform along the readout direction before the UKF reduces the size of the error covariance matrix P and improves the memory efficiency of the calculation. However, it may also reduce the correlation information between different phase encoding lines, and thus not capitalize on some potential improvements in estimation accuracy. Without using this 1D simplification, embodiments of the UKF Method can be adapted to other trajectories, such as spiral and radial, with a nonuniform Fourier transform F in Eq. [3].

In some embodiments, the UKF Method may compute T2 maps directly, without reconstructing T2-weighted images. For applications that require such images, a T2-weighted image can be generated based on the resulting T2 and ρ maps.

The performance of compressed sensing strongly depends on the undersampling pattern, and this is also true for UKF and Sumpf's CG methods. Simple undersampling patterns were used in the disclosed experiments. It is contemplated that an optimal undersampling pattern design could improve the performance of both the UKF and CG methods. Based on the disclosed experiments, embodiments of the UKF Method proved to be more precise than the CG Method, but more work is needed to determine whether this will be true in general. At a minimum, the disclosed experiments demonstrate that established methods of state tracking can be competitive with nonlinear inversion methods for MR parameter estimation. Much of the power of both classes of methods rests on their ability to incorporate prior information.

In conclusion, a method for tissue parameter mapping based on the UKF may estimate the parameter map directly from the k-p-space data and provide accurate estimation of T2 maps, and other tissue parameter maps, at high acceleration factors.

### CONCLUSION

The specific configurations, choice of materials and chemicals, and the size and shape of various elements can be varied according to particular design specifications or constraints requiring a system or method constructed according to the principles of the present disclosure. For example, while certain example ranges have been provided for the search windows and patch sizes, for example, other resolutions could be used depending on the application and the desired final image resolution. Such changes are intended to be embraced within the scope of the present disclosure. The presently disclosed embodiments, therefore, are considered in all respects to be illustrative and not restrictive. The scope of the present invention is indicated by the appended claims, rather than the foregoing description, and all changes that come within the meaning and range of equivalents thereof are intended to be embraced therein.

### LIST OF REFERENCES

1. Chan I, Wells W, Mulkern R V, Haker S, Zhang J, Zou K H, Maier S E, Tempany C M C. Detection of prostate cancer by integration of line-scan diffusion, T2-mapping and T2-weighted magnetic resonance imaging; a multichannel statistical classifier. Med. Phys. 2003; 30:2390-2398.
2. Oh J, Cha S, Aiken A H, Han E T, Crane J C, Stainsby J A, Wright G A, Dillon W P, Nelson S J. Quantitative apparent diffusion coefficients and T2 relaxation times in characterizing contrast enhancing brain tumors and regions of peritumoral edema. J. Magn. Reson. Imaging 2005; 21:701-708.
3. Siemonsen S, Mouridsen K, Holst B, Ries T, Finsterbusch J, Ostergaard L, Fiehler J, Thomalla G. Quantitative T2 values predict time from symptom onset in acute stroke patients. Stroke. 2009; 40:1612-1616.
4. Giri S, Chung Y-C, Merchant A, Mihai G, Rajagopalan S, Raman S V, Simonetti O P. T2 quantification for improved detection of myocardial edema. J. Cardiovasc. Magn. Reson. 2009; 11:56.
5. Baudrexel S, Nürnberger L, Rüb U, Seifried C, Klein J C, Deller T, Steinmetz H, Deichmann R, Hilker R. Quantitative mapping of T1 and T2* discloses nigral and brainstem pathology in early Parkinson's disease. Neuroimage 2010; 51:512-520.
6. Dai W, Robson P M, Shankaranarayanan A, Alsop D C. Reduced resolution transit delay prescan for quantitative continuous arterial spin labeling perfusion imaging. Magn. Reson. Med. 2012; 67:1252-1265.
7. Liu F, Chaudhary R, Hurley S A, Samosonov A, Alexander A, Deoni S C, Block W F, Kijowski R. Multi-Component T2 Analysis of Cartilage Degradation Model Using mcDESPOT at 3.0T. Proc. Sci. Meet. Int. Soc. Magn. Reson. Med. 2013:1655.
8. Doneva M, Börnert P, Eggers H, Stehning C, Sénégas J, Mertins A. Compressed sensing reconstruction for magnetic resonance parameter mapping. Magn. Reson. Med. 2010; 64:1114-1120.
9. Pruessmann K P, Weiger M, Scheidegger M B, Boesiger P. SENSE: sensitivity encoding for fast MRI. Magn. Reson. Med. 1999; 42:952-962.
10. Griswold M A a, Jakob P M M, Heidemann R M M, Nittka M, Jellus V, Wang J, Kiefer B, Haase A. Generalized autocalibrating partially parallel acquisitions (GRAPPA). Magn. Reson. Med. 2002; 47:1202-1210.
11. Lustig M, Donoho D, Pauly J M. Sparse MRI: The application of compressed sensing for rapid M R imaging. Magn. Reson. Med. 2007; 58:1182-1195.
12. Zhang T, Pauly J M, Levesque I R. Accelerating Parameter Mapping with a Locally Low Rank Constraint. 2014; 00:1-7.
13. Velikina J V., Alexander A L, Samsonov A. Accelerating M R parameter mapping using sparsity-promoting regularization in parametric dimension. Magn. Reson. Med. 2013; 70:1263-1273.
14. Huang C, Graff C G, Clarkson E W, Bilgin A, Altbach M I. T2 mapping from highly undersampled data by reconstruction of principal component coefficient maps using compressed sensing. Magn. Reson. Med. 2012; 67:1355-1366.
15. Block K T, Uecker M, Frahm J. Model-based iterative reconstruction for radial fast spin-echo MRI. IEEE Trans Med Imaging 2009; 28:1759-1769.
16. Sumpf T J, Uecker M, Boretius S, Frahm J. Model-based nonlinear inverse reconstruction for T2 mapping using highly undersampled spin-echo MRI. J. Magn. Reson. Imaging. 2011; 34:420-8.
17. Sümbül U, Santos J M, Pauly J M. A practical acceleration algorithm for real-time imaging. IEEE Trans. Med. Imaging 2009; 28:2042-2051.
18. Feng X, Salerno M, Kramer C M, Meyer C H. Kalman filter techniques for accelerated Cartesian dynamic cardiac imaging. Magn Reson Med 2012; 69:1346-1356.
19. Zhao L, Meyer C H. Direct & accelerated parameter mapping using the unscented Kalman filter Li. Proc. Intl. Soc. Mag. Reson. Med 2014; 22:3129.
20. Wan E, Merwe R Van Der, Nelson A. Dual Estimation and the Unscented Transformation. Neural Inf. Process. Syst. 2000:666-672.
21. Welch G, Bishop G. An Introduction to the Kalman Filter. Univ. North Carolina 2001.
22. Wan E A, Merwe R Van Der. The unscented Kalman filter for nonlinear estimation. Proc. IEEE 2000 Adapt. Syst. Signal Process. Commun. Control Symp. 2000:153-158.
23. Guerquin-Kern M, Lejeune L, Pruessmann K P, Unser M. Realistic analytical phantoms for parallel magnetic resonance imaging. IEEE Trans. Med. Imaging 2012; 31:626-636.
24. Wang Z, Bovik A C, Sheikh H R, Simoncelli E P. Image quality assessment: from error visibility to structural similarity. IEEE Trans Image Process. 2004; 13:600-612.
25. Olafsson V T, Noll D C, Fessler J A. Fast joint reconstruction of dynamic R2* and field maps in functional MRI. IEEE Trans. Med. Imaging. 2008; 27:1177-1188.
26. Huang C, Bilgin A, Barr T, Altbach M I. T2 relaxometry with indirect echo compensation from highly undersampled data. Magn. Reson. Med. 2013; 70:1026-37.
27. Ben-Eliezer N, Sodickson D K, Block K T. Rapid and accurate T2 mapping from multi-spin-echo data using Bloch-simulation-based reconstruction. Magn. Reson. Med. 2014; 73:809-817.
28. Sumpf T J, Petrovic A, Uecker M, Knoll F, Frahm J. Fast T2 mapping with improved accuracy using undersampled spin-echo MRI and model-based reconstructions with a generating function. IEEE Trans Med Imaging. 2014 December; 33(12):2213-22.
29. Poon C S, Henkelman R M. Practical T2 quantitation for clinical applications. J. Magn. Reson. Imaging 1992; 2:541-553.

What is claimed is:

1. A method for T2 mapping, comprising:
acquiring, by a magnetic resonance imaging (MRI) system, undersampled k-space data corresponding to a dynamic physiological process in an area of interest of a subject;
estimating, from the undersampled k-space data, one or more respective T2 values representing a respective state of the dynamic process at each point in time of a predetermined plurality of points in time during the acquisition, wherein the estimation comprises unscented Kalman filtering; and
generating one or more T2 maps using the respective plurality of estimated T2 values.

2. The method of claim 1, wherein the unscented Kalman filtering comprises:
performing a state transition function associated with one or more transitions between the states of the dynamic process; and
performing a measurement function associated with a relationship between the one or more estimated T2 values and an acquired signal corresponding to the undersampled k-space data.

3. The method of claim 2, wherein the measurement function models T2 encoding and Fourier encoding steps.

4. The method of claim 2, wherein the state transition function comprises combining the one or more respective T2 values associated with the respective state of the dynamic process with a noise value associated with the respective state.

5. The method of claim 2, wherein the measurement function comprises combining a noise value associated with the MRI system with a product of an undersampling pattern at a particular state of the states of the dynamic process, a Fourier transform operator, a coil sensitivity map associated with the MRI system, and a T2-weighted image at the particular state.

6. The method of claim 1, wherein acquiring the undersampled k-space data comprises using a multiple contrast spin echo sequence, each echo being configured to acquire a phase encoding value selected according to a predetermined undersampling pattern.

7. The method of claim 6, wherein the predetermined undersampling pattern comprises a plurality of phase-encoding lines and a plurality of outer k-space lines at each echo, the plurality of phase-encoding lines having the same quantity of phase-encoding lines at each echo.

8. The method of claim 1, wherein generating the one or more T2 maps comprises generating the one or more T2 maps directly from the undersampled k-space data.

9. The method of claim 8, further comprising generating one or more T2-weighted images based on the one or more T2 maps.

10. The method of claim 1, wherein:
estimating the one or more respective T2 values further comprises estimating, from the undersampled k-space data, one or more respective proton density values representing the respective states of the dynamic process at each point in time of the predetermined plurality of points in time during the acquisition; and
generating the one or more T2 maps further comprises generating the one or more T2 maps using the respective plurality of estimated T2 values and the respective plurality of estimated proton density values.

11. A system for tissue parameter mapping, comprising:
a data collection device configured to collect undersampled k-space data corresponding to a dynamic physiological process in an area of interest of a subject; and
an image processing device coupled to the data collection device, the image processing device comprising:
an estimating module configured to estimate, from the undersampled k-space data, one or more tissue parameter values associated with a state of the dynamic process at each of a predetermined plurality of points in time during the acquisition, and
a generating module configured to generate one or more tissue parameter maps using the respective plurality of estimated tissue parameter values.

12. The system for tissue parameter mapping of claim 11, wherein the data collection device comprises a magnetic resonance imaging (MRI) device configured to acquire the undersampled k-space data.

13. The system for tissue parameter mapping of claim 12, wherein the image processing device comprises at least one processor configured to execute computer-readable instructions to cause a computing device to perform functions comprising acquiring the undersampled k-space data, estimating the one or more tissue parameter values, and generating of the one or more tissue parameter maps.

14. The system for tissue parameter mapping of claim 11, wherein the estimation comprises unscented Kalman filtering.

15. The system for tissue parameter mapping of claim 14, wherein the unscented Kalman filtering comprises:
performing a state transition function associated with one or more transitions between the states of the dynamic process; and
performing a measurement function associated with a relationship between the one or more estimated tissue parameter values and an acquired signal corresponding to the undersampled k-space data.

16. The system for tissue parameter mapping of claim 15, wherein the measurement function models tissue parameter encoding and Fourier encoding steps.

17. The system for tissue parameter mapping of claim 15, wherein the state transition function comprises combining the one or more respective tissue parameter values associated with the respective state of the dynamic process with a noise value associated with the respective state.

18. The system for tissue parameter mapping of claim 15, wherein the measurement function comprises combining a noise value associated with the data collection device with a product of an undersampling pattern at a particular state of the states of the dynamic process, a Fourier transform operator, a coil sensitivity map associated with the data collection device, and a tissue parameter-weighted image at the particular state.

19. The system for tissue parameter mapping of claim 11, wherein collecting the undersampled k-space data comprises using a multiple contrast spin echo sequence, each echo being configured to acquire a phase encoding value selected according to a predetermined undersampling pattern.

20. The system for tissue parameter mapping of claim 19, wherein the predetermined undersampling pattern comprises a plurality of phase-encoding lines and a plurality of outer k-space lines at each echo, the plurality of phase-encoding lines having the same quantity of phase-encoding lines at each echo.

21. The system for tissue parameter mapping of claim 11, wherein generating the one or more tissue parameter maps comprises generating the one or more tissue parameter maps directly from the undersampled k-space data.

22. The system for tissue parameter mapping of claim 21, wherein the generating module is further configured to generate one or more tissue parameter-weighted images based on the one or more tissue parameter maps.

23. A method for tissue parameter mapping, comprising:
receiving undersampled k-space data corresponding to a dynamic physiological process in an area of interest of a subject;
estimating, from the undersampled k-space data, one or more respective tissue parameter values representing a respective state of the dynamic process at each point in time of a predetermined plurality of points in time during the acquisition, wherein the estimation comprises unscented Kalman filtering; and
generating one or more tissue parameter maps using the respective plurality of estimated tissue parameter values.

24. The method of claim 23, wherein the one or more tissue parameter values comprises one or more of T1, T2, T2*, perfusion parameter, and diffusion parameter values, and the one or more tissue parameter maps comprises one or more of T1, T2, T2*, perfusion parameter, and diffusion parameter maps.

25. The method of claim 23, wherein the estimation comprises simultaneously estimating a plurality of the tissue parameter values.

26. The method of claim 23, wherein receiving the undersampled k-space data comprises acquiring the undersampled k-space data using a magnetic resonance imaging (MRI) device.

27. The method of claim 23, further comprising:
estimating, from the undersampled k-space data, a second tissue parameter value representing a respective state of the dynamic process at each point in time of a predetermined plurality of points in time during the acquisition, wherein the second tissue parameter estimation comprises unscented Kalman filtering; and
generating one or more of a second tissue parameter map using the respective plurality of estimated second tissue parameter values.

28. The method of claim 23, wherein the unscented Kalman filtering comprises:
performing a state transition function associated with one or more transitions between the states of the dynamic process; and
performing a measurement function associated with a relationship between the one or more estimated tissue parameter values and an acquired signal corresponding to the undersampled k-space data.

29. The method of claim 28, wherein the measurement function models tissue parameter encoding and Fourier encoding steps.

30. The method of claim 28, wherein the state transition function comprises combining the one or more respective tissue parameter values associated with the respective state of the dynamic process with a noise value associated with the respective state.

31. The method of claim 28, wherein the measurement function comprises combining a noise value associated with the data collection device with a product of an undersampling pattern at a particular state of the states of the dynamic process, a Fourier transform operator, a coil sensitivity map associated with the data collection device, and a tissue parameter-weighted image at the particular state.

32. The method of claim 28, wherein receiving the undersampled k-space data comprises using a multiple contrast spin echo sequence, each echo being configured to acquire a phase encoding value selected according to a predetermined undersampling pattern.

33. The method of claim 32, wherein the predetermined undersampling pattern comprises a plurality of phase-encoding lines and a plurality of outer k-space lines at each echo, the plurality of phase-encoding lines having the same quantity of phase-encoding lines at each echo.

34. The method of claim 23, wherein generating the one or more tissue parameter maps comprises generating the one or more tissue parameter maps directly from the undersampled k-space data.

35. The method of claim 23, further comprising generating one or more tissue parameter-weighted images based on the one or more tissue parameter maps.

36. A non-transitory computer-readable storage medium having stored computer-executable instructions that, when executed by one or more processors, cause a computer to perform functions comprising:
receiving undersampled k-space data corresponding to a dynamic physiological process in an area of interest of a subject;
estimating, from the undersampled k-space data, one or more respective tissue parameter values representing a respective state of the dynamic process at each point in time of a predetermined plurality of points in time during the acquisition, wherein the estimation comprises unscented Kalman filtering; and
generating one or more tissue parameter maps using the respective plurality of estimated tissue parameter values.

37. The non-transitory computer-readable storage medium of claim 36, wherein the one or more tissue parameter values comprises one or more of T1, T2, T2*, perfusion parameter, and diffusion parameter values, and the one or more tissue parameter maps comprises one or more of T1, T2, T2*, perfusion parameter, and diffusion parameter maps.

38. The non-transitory computer-readable storage medium of claim 36, wherein the estimation comprises simultaneously estimating a plurality of the tissue parameter values.

39. The non-transitory computer-readable storage medium of claim 36, wherein receiving the undersampled k-space data comprises acquiring the undersampled k-space data using a magnetic resonance imaging (MRI) device.

40. The non-transitory computer-readable storage medium of claim 36, wherein the functions performed by the computer further comprise:
estimating, from the undersampled k-space data, a second tissue parameter value representing a respective state of the dynamic process at each point in time of a predetermined plurality of points in time during the acquisition, wherein the second tissue parameter estimation comprises unscented Kalman filtering; and
generating one or more of a second tissue parameter map using the respective plurality of estimated second tissue parameter values.

41. The non-transitory computer-readable storage medium of claim 36, wherein the unscented Kalman filtering comprises:
performing a state transition function associated with one or more transitions between the states of the dynamic process; and
performing a measurement function associated with a relationship between the one or more estimated tissue parameter values and an acquired signal corresponding to the undersampled k-space data.

42. The non-transitory computer-readable storage medium of claim 41, wherein the measurement function models tissue parameter encoding and Fourier encoding steps.

43. The non-transitory computer-readable storage medium of claim 41, wherein the state transition function comprises combining the one or more respective tissue parameter values associated with the respective state of the dynamic process with a noise value associated with the respective state.

44. The non-transitory computer-readable storage medium of claim 41, wherein the measurement function comprises combining a noise value associated with the data collection device with a product of an undersampling pattern at a particular state of the states of the dynamic process, a Fourier transform operator, a coil sensitivity map associated with the data collection device, and a tissue parameter-weighted image at the particular state.

45. The non-transitory computer-readable storage medium of claim 41, wherein receiving the undersampled k-space data comprises using a multiple contrast spin echo sequence, each echo being configured to acquire a phase encoding value selected according to a predetermined undersampling pattern.

46. The non-transitory computer-readable storage medium of claim 45, wherein the predetermined undersampling pattern comprises a plurality of phase-encoding lines and a plurality of outer k-space lines at each echo, the plurality of phase-encoding lines having the same quantity of phase-encoding lines at each echo.

47. The non-transitory computer-readable storage medium of claim 36, wherein generating the one or more tissue parameter maps comprises generating the one or more tissue parameter maps directly from the undersampled k-space data.

48. The non-transitory computer-readable storage medium of claim 36, wherein the functions performed by the computer further comprise generating one or more tissue parameter-weighted images based on the one or more tissue parameter maps.
